(19) United States
(12) Patent Application Publication
(10) Pub. No.: US 2010/0273017 A1
(43) Pub. Date: Oct. 28, 2010

(54) Hybrid Packaging Material

(76) Inventor: John C. Files, Vancouver, WA (US)

Correspondence Address: WOMBLE CARLYLE SANDRIDGE & RICE, PLLC, ATTN: PATENT DOCKETING, P.O. BOX 7037, ATLANTA, GA, 30357-0037, US

(21) Appl. No.: 12/776,468

(22) Filed: May 10, 2010

Related U.S. Application Data
(63) Continuation-in-part of application No. 12/616,371, filed on Nov. 11, 2009.
Application No. 12/616,371 is a continuation-in-part of application No. 11/824,175, filed on Jun. 28, 2007, now abandoned.
(60) Provisional application No. 60/817,488, filed on Jun. 29, 2006.
(60) Provisional application No. 61/247,983, filed on Oct. 2, 2009.

(51) Int. Cl. B32B 27/10; B32B 27/00

(52) U.S. Cl. 428/513; 428/511

(57) ABSTRACT

A packaging material includes a polymer film layer, a paper layer, a tie layer joining the paper layer and the polymer film layer, and a pair of opposed sides, each comprising a heat sealable material. The heat sealable material of the second side comprises a blend of linear low density polyethylene, low density polyethylene, and ethylene/methacrylic acid copolymer.

### CROSS-REFERENCE TO RELATED APPLICATIONS

This application is a continuation-in-part of U.S. patent application Ser. No. 12/616,371, filed Nov. 11, 2009, which is a continuation-in-part of U.S. patent application Ser. No. 11/824,175, filed Jun. 28, 2007, now abandoned, which claims the benefit of U.S. Provisional Application No. 60/817,488, filed Jun. 29, 2006. This application also claims the benefit of U.S. Provisional Application No. 61/247,983, filed Oct. 2, 2009. Each of the above applications is incorporated by reference in its entirety.

### OTHER RELATED APPLICATIONS

This application is related to U.S. patent application Ser. No. ______, filed May 10, 2010, titled “High Strength Packages and Packaging Materials” (Attorney Docket No. R029 13443.1), U.S. patent application Ser. No. ______, filed May 10, 2010, titled “High Strength Packages and Packaging Materials” (Attorney Docket No. R029 13444.1), and U.S. patent application Ser. No. ______, filed May 10, 2010, titled “Heat Sealing Systems and Methods, and Related Articles and Materials” (Attorney Docket No. R029 15930.1), each of which is incorporated by reference herein in its entirety.

### BACKGROUND

Paper-based bags frequently are used to package food items or other products, such as French fries, hash browns, breaded chicken, and pet food. However, such items often are coated with oils that are capable of permeating the paper or paperboard. When oils penetrate the packaging, a darkened area or stain appears on the outside of the package. Such staining detracts from the appearance of the packaging, which may be viewed as damaged or contaminated. Thus, there remains a need for packages and packaging materials that resist staining by oils, mask staining by oils, or any combination thereof, and that offer resistance to damage from contact with other liquids, for example, water.

As a result, polymer films may be considered for use in such packages. However, packages formed from polymer films lack the stiffness needed for many applications. For example, to achieve the stiffness of a typical paper bag, the polymer film may need to have a thickness of about 3 to 4 mil. Unfortunately, polymer films of this thickness are often difficult to process (e.g., cut into packages) and may be cost prohibitive. Additionally, such materials lack the ecological appeal of a sustainable material, such as paper.

Thus, there remains a need for a packaging material that offers the advantages of both paper-based packaging materials and polymer-based packaging materials.

### SUMMARY

This disclosure relates generally to a material for forming a package (i.e., a packaging material) and a method of making the packaging material. The packaging material may comprise a layered structure including at least one polymer film layer and at least one paper layer, and therefore, may be referred to as a “hybrid” packaging material.

The packaging material may include one or more tie layers to improve adhesion (e.g., hot tack and/or seal strength) between various layers, for example, between the polymer film layer and the paper layer.

The packaging material may include at least one heat sealable surface to facilitate formation of a package or other construct from the packaging material. In some embodiments, the polymer film layer may comprise an outermost layer of the packaging material such that the polymer film layer defines a first side of the packaging material. In such embodiments, the polymer film layer may be heat sealable. Likewise, in some embodiments, a second side of the packaging material may comprise a heat sealable material, for example, a heat sealable polymer or polymeric material. The polymer layer may comprise a blend of materials, for example, linear low density polyethylene, low density polyethylene, and ethylene/methacrylic acid. Still other layers may be incorporated to serve other functions.

The packaging material may be used to form various packages or other constructs. In some instances, the packaging material may be used for packaging a food item that is coated with or contains an oily or greasy substance, for example, a trans fatty acid oil, a low trans fatty acid oil, a non-trans fatty acid oil, a saturated oil, an unsaturated oil, grease, fat, or butter (collectively “oil” or “oils”), that may penetrate one or more components of the packaging material. In such instances, the packaging material may include features for resisting oil penetration, masking oil penetration, or for both resisting and masking oil penetration. For example, the packaging material may include an oil resistant layer, a stain masking layer, any other suitable feature, or any combination thereof. In some particular examples, the packaging material may be used to form packages or other constructs for containing food items, pet food, bird seed, or any other suitable item. Other applications are contemplated.

The hybrid packaging material provides numerous advantages over traditional packaging materials. For example, as compared with polymer-only packaging materials, the present packaging material may provide a greater degree of stiffness, which may be needed to form gussets or other packaging features, and/or may be desirable to provide easier handling of the packages. The packaging material may also be lower in cost and more eco-friendly due to its use of sustainable materials such as paper.

Further, the paper layer of the present packaging material may impart some tearability to the packaging material, particularly where a heat seal is formed on a side of the packaging material adjacent to the paper layer. In such instances, the heat seal may be just weak enough that a consumer can open the panels of the package without excessive difficulty. In contrast, heavier weight polymer film packaging materials are often difficult to cut during processing and the seals are so strong the consumer cannot open them without cutting the package with a sharp implement.

Likewise, as compared with paper-only packaging materials, the present packaging material may provide a barrier to water, oil, and other contaminants, may be readily heat sealable on one or both sides, and may have enhanced strength. Also, the polymer film layer of the packaging material may be reverse printed, which provides excellent print quality and abrasion resistance.

Thus, the hybrid structure advantageously maximizes the benefits of both paper and polymer film packaging materials. Other aspects and features of the present invention will become apparent in view of the figures and the following description.

### BRIEF DESCRIPTION OF THE DRAWINGS

The description refers to the accompanying drawings, some of which are schematic, in which like reference characters refer to like parts throughout the several views, and in which:

FIG. 1 is a schematic cross-sectional view of an exemplary packaging material according to the disclosure;

FIG. 2 presents the hot tack strength of various structures that may be suitable for use as a packaging material; and

FIG. 3 presents the seal strength of various structures that may be suitable for use as a packaging material.

### DESCRIPTION

Various aspects of the invention may be illustrated by referring to the figures, which depict examples of packaging materials. For purposes of simplicity, like numerals may be used to describe like features. Although several different exemplary aspects, implementations, and embodiments of the various inventions are provided, numerous interrelationships between, combinations thereof, and modifications of the various inventions, aspects, implementations, and embodiments are contemplated hereby.

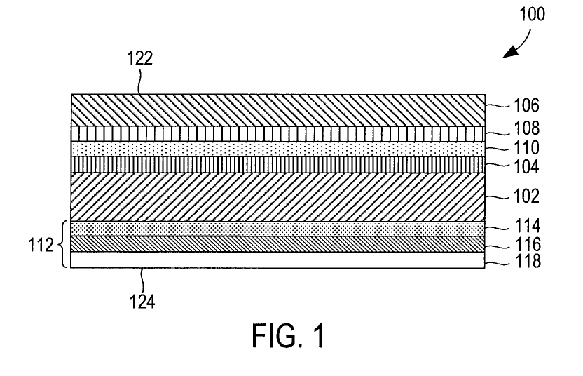

FIG. 1 depicts a schematic cross-sectional view of an exemplary packaging material 100. The packaging material 100 generally includes a plurality of layers joined to one another. For purposes of convenience, some layers may be described as “overlying” or being disposed “on” other layers. However, it will be appreciated that the packaging material 100 may be inverted, such that other layers “overlie” or are “on” one another. Accordingly, such terminology is provided merely for convenience of explanation and not limitation in any manner.

Further, while one specific structure 100 is illustrated schematically in FIG. 1, it will be appreciated that numerous other packaging materials are contemplated by the disclosure, and that each of such packaging materials may include various layers. Layers may be added or omitted as needed. It also will be appreciated that various materials may be used to form each layer of the packaging material, and that each layer may have various basis weights or coat weights and may be present in the packaging material in any suitable relative amount, depending on the particular application. Further, it will be appreciated that each layer may serve more than one purpose in a particular packaging material, and that the layer names are provided for convenience of explanation and not limitation in any manner.

In the illustrated embodiment, the packaging material 100 includes a substrate 102, which may be optionally provided with a stain masking layer 104, a polymer film layer 106 (e.g., a heat sealable polymer film), which may be optionally printed with ink 108, and a tie layer 110 (e.g., a first tie layer) disposed between the substrate 102 and the heat sealable film layer 106. If desired, the packaging material 100 also may include a grease resistant, heat sealable polymer system 112 overlying a second side of the substrate 102 opposite the optional grease masking layer 104. The polymer system 112 may include a tie layer 114 (e.g., a second tie layer) adjacent to the second side of the substrate 102, a core layer 116 (e.g., an oil resistant layer), and a heat seal layer 118 (e.g., a second heat seal layer).

Each layer 102, 104, 106, 108, 110, 114, 116, 118 is in a substantially facing, contacting relationship with the respective adjacent layer(s) or material. When used to form a package, the heat sealable film layer 106 (i.e., the outermost surface of the heat sealable film layer 106) generally faces outwardly and/or at least partially defines the exterior surface of the package, and the heat seal layer 118 (i.e., the outermost surface of the heat seal layer 118) generally faces inwardly and/or defines the interior surface of the package.

The substrate 102 generally comprises a base material, for example, paper or paperboard, from which the packaging material 100 is formed. The paper or paperboard may have a basis weight of from about 8 to about 250 lb/ream (250 lb/3000 square feet), for example, about 30 to about 100 lb/ream, for example, from about 40 to about 80 lb/ream. In one specific example, the substrate may comprise Kraft paper having a basis weight of about 60 lb/ream. However, other ranges and basis weights and other substrates may be used.

Where the substrate 102 comprises a material that is susceptible to penetration and/or staining by oil, for example, paper, the packaging material 100 may include one or more features or components that mask staining of a substrate by oil. It has been found that oil may cause some substrates to become translucent or transparent, thereby creating a visibly darker area (i.e., stain) on, for example, paper, particularly where there is a score, seam, abrasion, aperture, or slit through the material (e.g., when the package is provided with slits to release air trapped in the package). Accordingly, at least a portion of the packaging material may be modified to mask the appearance of a darkened region created by oil penetration.

In one example, the stain masking layer 104 may overlie all or a portion of the substrate 102. The stain masking layer 104 may mask a stain, for example, by reducing or eliminating the darkened appearance of the stained substrate 102 (e.g., paper). The stain masking layer 104 may generally comprise one or more layers of material that conceal the stain (e.g., materials that are dark), that closely resemble the color of the stain, that obscure the glossiness of the stain, or any combination thereof. In one example, the stain masking layer may comprise a colorant mixture including a dark, non-reflective pigment, for example, carbon black, and a reflective pigment, for example, aluminum flake. The reflective pigment and non-reflective pigment may be used in any suitable ratio. In each of various examples, the colorant mixture may include carbon black and aluminum flake in a ratio of about 6.15:1, about 6:1, about 2.15:1, or about 2:1. Other ratios are contemplated. Further, the stain masking layer may include additional components if desired. Other stain masking concepts that may be suitable for use with the packaging material 100 are disclosed in U.S. patent application Ser. No. 12/616,371, filed Nov. 11, 2009, which is incorporated by reference herein in its entirety.

The stain masking layer 104 may have any suitable basis weight as needed to achieve the desired stain masking effect. In some embodiments, the stain masking layer may have a basis weight of from about 1 to about 6 lb/ream, for example, from about 2 to about 4 lb/ream. The stain masking layer 104 may be continuous or discontinuous, such that the stain masking layer may overlie all or a portion of the substrate 102.

The polymer film layer 106 may be used to impart strength, water resistance, and/or heat sealability to the packaging material 100. Where heat sealability is desired, the polymer film layer 106 may generally comprise any suitable thermoplastic polymer having a sufficiently low melting or softening point so the heat seal can be initiated at a relatively low temperature (“heat seal temperature”), for example, from about 180° F. to about 300° F. Additionally, the heat sealable polymer film layer 106 may be selected to provide a wide hot tack sealing window, such that the heat seal may be formed over a range of temperatures with the degree of tackiness for the desired duration. In one example, the heat sealable film layer 106 comprises polypropylene (PP), for example, biaxially oriented polypropylene (BOPP). The heat sealable film layer 106 may include printing on the exterior surface of the film or may be reverse printed with one or more layers of ink 108 if desired, as shown in FIG. 1.

In another embodiment (not shown), the polymer film layer 106 may be used to provide strength and/or water resistance, while another layer (not shown) may be provided for heat sealability. Countless possibilities are contemplated.

The heat sealable film layer 106 may have any suitable thickness (i.e., caliper), for example, from about 80 to about 160 gauge, for example, from about 100 to about 140 gauge. In one particular example, the film may have a thickness of about 120 gauge. Other suitable thicknesses and ranges of thicknesses are contemplated.

The tie layer 110 generally serves to join two adjacent layers, in this example, the heat sealable film layer 106 and the substrate 102, where such layers are incompatible or otherwise unable to adhere to one another sufficiently.

The tie layer 110 may have any suitable composition, as needed to join the adjacent layers. In one example, the tie layer comprises a blend of low density polyethylene (LDPE) and polypropylene (PP). The present inventors have discovered that this exemplary blend provides superior processability and adhesive properties with a variety of substrates. For example, it is well known that it is difficult to adhere polypropylene (PP) (e.g., in the heat sealable film layer 106) to paper (e.g., substrate 102) at high processing speeds. However, the present inventors have found that by combining LDPE with PP, the blend has a greater affinity for both PP film and paper. While not wishing to be bound by theory, it is believed that the relatively low melting LDPE flows into the spaces between the fibers of the paper and the PP increases the compatibility with the film layer 108.

The tie layer 110 may have any suitable basis weight as needed to attain the desired level of adhesion between the adjacent layers. For example, the tie layer 106 may have a basis weight of from about 1 to about 15 lb/ream, for example, from about 6 to about 10 lb/ream. In one specific example, the tie layer may have a basis weight of about 8 lb/ream. However, other ranges and basis weights are contemplated.

The relative amounts of LDPE and PP in the tie layer 110 may vary for each application. In some examples, the blend may generally comprise from about 70% to about 95% LDPE and about 5% to about 30% PP (by weight), for example, from about 80% to about 90% LDPE and about 10% to about 20% PP. In one exemplary embodiment, the blend may comprise about 85% LDPE and about 15% PP. However, other suitable amounts and ratios of LDPE and PP may be used.

In other embodiments, the tie layer may comprise linear low density polyethylene (LLDPE), LDPE, or any suitable blend of LLDPE (e.g., m-LLDPE), LDPE, and ethylene/methacrylic acid copolymer (EMA). Some of such exemplary blends are discussed below with respect to the heat seal layer 118. However, other blends and other tie layer compositions are contemplated.

Still viewing FIG. 1A, the polymer system 112 may be used to impart numerous properties to the packaging material 100. Thus, while the layers of the polymer system 112 may be described independently, it will be appreciated that the layers cooperate with one another to enhance the packaging material 100, as will be discussed below.

The heat seal layer 118 generally renders the interior side of the packaging material 100 heat sealable. This may be desirable for numerous package configurations. The core layer 116 generally comprises a polymer layer, which may, if desired, impart various attributes to the packaging material 100. By way of example, and not limitation, the core layer 116 may serve as an oil resistant layer (i.e., as a barrier layer to oils). This may be important where the contents of the package include a fatty or oily component, for example, as with pet food, bird seed, etc. The tie layer 114 generally joins the core layer 116 to the substrate 102.

In some instances, the core layer 116 may be selected to have a melting point that is greater than the heat seal temperature to ensure that the integrity of the core layer 116 is maintained during the heat sealing process. In other instances, the core layer 116 may comprise a blend of materials, at least one of which may have a melting point less than the heat seal temperature. In such embodiments, the lower melting components may soften during the heat sealing process, such that a portion of the core layer 116 serves as a heat seal material or layer in conjunction with heat seal layer 118. Thus, depending on the materials selected, each of the various layers 114, 116, 118 may cooperate in various ways to achieve a desired result.

In one exemplary embodiment, the heat seal layer 118 may comprise a blend of linear low density polyethylene (LLDPE), low density polyethylene (LDPE), and an ethylene/methacrylic acid copolymer (EMA). The LLDPE may be a metallocene LLDPE (m-LLDPE). The ratio of each component may vary for each application. In one example, the blend may comprise from about 60% to 100% LLDPE, from 0 to about 35% LDPE, and from 0 to about 5% EMA (by weight). In another example, the blend may comprise from about 60% to about 80% LLDPE, from about 15% to about 35% LDPE, and from about 1 to about 5% EMA. In still another example, the blend may comprise about 60% LLDPE, about 35% LDPE, and about 5% EMA, such that the ratio of the components is about 12:7:1. However, other blends of LLDPE, LDPE, and EMA are contemplated.

The present inventors have found that a blend of LLDPE, LDPE, and EMA offers superior processability and resulting heat seal strength. Specifically, the present inventors have found that by adding LLDPE to LDPE, the melting point (and, therefore, the heat seal temperature) is lowered from about 230° F. to about 220° F., and that by adding EMA to the mixture of LLDPE and LDPE, the melting point (and, therefore, the heat seal temperature) of the blend is lowered to about 210-215° F. As a result, the heat seal may be initiated at a lower temperature, which allows for the packaging material 100 to be heat sealed at greater processing speeds. The present inventors have also found that the heat seal formed from the blend of LLDPE, LDPE, and EMA has superior strength relative to a heat seal formed from any of the individual components.

While various LLPDEs, LDPEs, and EMAs may be used, one example of an LLDPE that may be suitable for use is Dow Affinity PT 1450G1 (Dow Chemical Co., Midland, Mich.) (believed to be m-LLDPE). While not wishing to be bound by theory, it is believed that Dow Affinity PT 1450G1 LLDPE may include one or more components that may enhance the affinity with PP. One example of an LDPE that may be suitable is Chevron 1018 LDPE (Chevron Phillips Chemical Co. LLC, The Woodlands, Tex.). Other examples of LDPEs that may be suitable include, but are not limited to, Westlake EC-482 (Westlake Chemical Corp., Houston, Tex.) and Marflex® 1013 LDPE (Phillips Chemical Co. LLC, The Woodlands, Tex.). One example of EMA that may be suitable is Surlyn® 1707 resin (DuPont Packaging and Industrial Polymers, Wilmington, Del.).

The heat seal layer 118 may have any suitable coat weight, for example, from about 1 to about 5 lb/ream, for example, from about 2 to about 4 lb/ream, for example, about 3 lb/ream. In one specific example, the heat seal layer 118 has a coat weight of about 3.06 lb/ream. Other coat weights and ranges are contemplated.

In other embodiments, the heat seal layer may comprise LLDPE (e.g., m-LLDPE), or any suitable blend of LLDPE (e.g., m-LLDPE) and EMA. For example, the heat seal layer may comprise a blend of about 95% m-LLDPE and about 5% EMA, about 90% m-LLDPE and about 10% EMA, about 85% m-LLDPE and about 15% EMA, and so on. However, other blends and other heat seal layer compositions are contemplated.

The tie layer 114 may be formed from any suitable material that sufficiently adheres to the adjacent layers. In one example, the tie layer 104 may comprise a blend of LLDPE, LDPE, and EMA, as described above. The ratio of each component may vary for each application. In one variation, the blend may comprise from about 60% to 100% LLDPE, from 0 to about 35% LDPE, and from 0 to about 5% EMA (by weight). In another variation, the blend may comprise from about 60% to about 80% LLDPE, from about 15% to about 35% LDPE, and from about 1 to about 5% EMA. In still another variation, the blend may comprise about 60% LLDPE, about 35% LDPE, and about 5% EMA, such that the ratio of the components is about 12:7:1. Other blends of LLDPE, LDPE, and EMA are contemplated.

The present inventors have discovered that this exemplary blend provides superior processability and adhesive properties with a variety of substrates. By way of illustration, and not limitation, it is well known that it is difficult to adhere polypropylene (PP) (e.g., in the core layer 116) to paper (e.g., substrate 102) at high processing speeds. However, the exemplary blend of LLDPE, LDPE, and EMA, which has a relatively low melting point (about 210-215° F. as compared with about 320° F. for PP), tends to flow readily into the paper, even at high processing speeds (e.g., 2000-2500 ft/min). Additionally, where Dow Affinity 1450G1 LLPDE is used, the present inventors have found that the tie layer 104 has a greater affinity for core layers including PP, as compared with other LLDPEs. While not wishing to be bound by theory, it is believed that the Dow Affinity 1450G1 LLDPE includes one or more components that enhance the affinity of the LLPDE to PP.

The tie layer 114 may have any suitable basis weight, for example, from about 0.5 to about 5 lb/ream, for example, from about 0.75 to about 2 lb/ream, for example, about 11b/ream. In one specific example, the tie layer 114 has a basis weight of about 1.19 lb/ream. Other ranges and basis weights are contemplated.

In one exemplary embodiment, the core layer 116 may comprise a blend of PP and LDPE. The relative amounts of PP and LDPE in the core layer 116 may vary for each application. The blend may generally comprise from about 70% to about 90% PP and about 10% to about 30% LDPE (by weight). In one example, the blend may comprise about 75% PP and about 25% LDPE. In another example, the blend may comprise about 80% PP and about 20% LDPE. In still another example, the blend may comprise about 85% PP and about 15% LDPE. However, other suitable amounts and ratios of LDPE and PP may be used.

The present inventors have discovered these exemplary blends of PP and LDPE in the core layer 116 provide an excellent balance of properties for various packaging materials. For example, as compared with a core layer 116 comprising only PP (i.e., without the LDPE), a core layer 116 including from about 80 to about 85% PP and about 15 to 20% LDPE (by weight) provides about the same level of oil resistance as a core layer 116 comprising 100% PP. Further, the presence of the LDPE improves adhesion with the adjacent layers. By way of example, where the heat seal layer 118 and/or the tie layer 114 comprise a blend of LLDPE, LDPE, and EMA (e.g., as discussed above), the blend of LDPE and PP in the core layer 116 has a greater affinity for the polymer blend of the heat seal layer 118 and/or the tie layer 114, as compared with PP alone.

Further, since LDPE has a lower melting point than PP (about 230° F. for LDPE and about 320° F. for PP), in some cases, depending on the heat seal temperature and other processing conditions, the LDPE in the core layer 116 and the tie layer 114 may soften during the heat sealing process, such that a part of the core layer 116 and tie layer 114 also effectively serves as part of the heat seal layer 118. In such cases, the basis weight of the heat seal layer 118 and/or the tie layer 114 may be reduced, thereby reducing the cost of the overall structure.

By way of illustration, the present inventors have found that a packaging material including:
a heat seal layer 118 having a basis weight of about 1.3 lb/ream and comprising a blend of about 60% LLDPE, about 35% LDPE, and about 5% EMA (by weight);
a core layer 116 having a basis weight of about 3.33 lb/ream and comprising an 80/20 blend of PP/LDPE; and
a tie layer 114 having a basis weight of about 0.37 lb/ream and comprising a blend of about 60% LLDPE, about 35% LDPE, and about 5% EMA,
   exhibited better peel strength (i.e., layer to layer adhesion) than a packaging material including:
a heat seal layer 118 having a basis weight of about 3.12 lb/ream and comprising a blend of about 60% LLDPE, about 35% LDPE, and about 5% EMA;
a core layer 116 having a basis weight of about 4 lb/ream and comprising PP; and
a tie layer 114 having a basis weight of about 0.88 lb/ream and comprising a blend of about 60% LLDPE, about 35% LDPE, and about 5% EMA.
   Thus, although each polymer system 112 had about the same basis weight (about 5 lb/ream), the packaging material including the blend of LDPE and PP in the core layer 116 exhibited superior peel strength at a reduced cost (based on the present cost of various polymers in each layer). While not wishing to be bound by theory, it is believed that this is because the presence of the LDPE in the core layer contributed to the overall heat sealability of the material, as discussed above.

Notably, the structure with the PP/LDPE core layer (2.66 lb/ream PP) also provided about the same level of oil resistance as the structure with about 4 lb/ream PP in the core layer. This is because the present inventors have discovered that oil resistance can be improved significantly by forming the packaging material in a specific manner. In particular, the present inventors have discovered that using a relatively low bond pressure (as compared with a typical bond pressure) to join the polymer system 112 to the substrate 102, the resulting weakly or loosely bonded structure exhibits greater oil resistance than a material formed using a high bond pressure (i.e., a highly or tightly bonded material), as disclosed in U.S. patent application Ser. No. 12/616,371, filed Nov. 11, 2009, which is incorporated by reference herein in its entirety. Thus, in this and other embodiments, a low bond pressure may be used to enhance oil resistance, which may result in a lesser amount of PP needed to achieve the same results.

It will be appreciated that the terms “typical bond pressure”, “low bond pressure”, and “high bond pressure” are relative terms that may depend on the type of package being made and numerous other process variables. By way of example, and not limitation, for some packaging materials, a typical bond pressure may be from about 125 to about 200 psi, a low bond pressure may be less than 125 psi, for example, from about 60 to about 70 psi, for example, for about 65 psi, and a high bond pressure may be greater than about 200 psi, for example, about 400 psi. Numerous other bond pressures may be used. Additionally, it will be noted that in some embodiments, a combination of high bond pressures and low bond pressures may be used to provide the desired level of tensile strength, hot tack strength, seal strength and oil resistance in the resulting packaging material.

The core layer 116 may generally have a basis weight of from about 1 to about 8 lb/ream, for example, from about 2 to about 6 lb/ream, for example, about 4 lb/ream. In one specific example, the basis weight of the core layer 116 is about 3.75 lb/ream. Other ranges and basis weights are contemplated.

The polymer system 112 (i.e., the heat seal layer 118, core layer 116, and tie layer 114) may have any suitable total basis weight. In each of various examples, the polymer system may have a basis weight of about 5 lb/ream, about 5.5 lb/ream, about 6 lb/ream, about 6.5 lb/ream, about 7 lb/ream, about 7.5 lb/ream, about 8 lb/ream, about 8.5 lb/ream, about 9 lb/ream, about 9.5 lb/ream, about 10 lb/ream, about 10.5 lb/ream, about 11 lb/ream, about 11.5 lb/ream, about 12 lb/ream, about 12.5 lb/ream, about 13 lb/ream, about 13.5 lb/ream, about 14 lb/ream, about 14.5 lb/ream, about 15 lb/ream, or any other suitable basis weight. The components of the polymer system 112 may be present in any suitable ratio. In one example, the weight % ratio of the heat seal layer 118, core layer 116, and tie layer 114 may be about 3.06:3.15:1.

However, other ratios are contemplated.

In one example, the heat seal layer 118 may have a basis weight of from about 1 to about 5 lb/ream, the core layer 116 may have a basis weight of from about 1 to about 8 lb/ream, and the tie layer 114 may have a basis weight of from about 0.5 to about 5 lb/ream. In another example, the heat seal layer 118 may have a basis weight of from about 2 to about 4 lb/ream, the core layer 116 may have a basis weight of from about 2 to about 6 lb/ream, and the tie layer 114 may have a basis weight of from about 0.75 to about 2 lb/ream. In one particular example, the heat seal layer 118 may have a basis weight of about 3 lb/ream, the core layer 116 may have a basis weight of about 4 lb/ream, and the tie layer 114 may have a basis weight of about 1 lb/ream. In another particular example, the heat seal layer 118 may have a basis weight of about 3.06 lb/ream, the core layer 116 may have a basis weight of about 3.75, and the tie layer 114 may have a basis weight of about 1.19 lb/ream.

The various layers of the packaging material may be formed, assembled, and/or joined using any method or technique known in the art. According to one exemplary method of forming the packaging material 100, the heat sealable film layer 106 may be printed with ink 108. The substrate 102 may be provided with a stain masking layer 104 (where used) via printing or any other suitable technique. The polymer system 112 may be then be extruded onto the substrate 102. The heat sealable film layer 106 and the substrate 102 may then be extrusion laminated to one another using the tie layer 110. However, numerous other steps and sequences of steps may be used.

Notably, the polymer system 112 may be formed using a two extruder system. By way of illustration, in this and other embodiments where two or more layers have the same composition (e.g., as with layers 114, 118), one extruder may be used to form layers 114, 118, and another may be used to form layer 116. In such an embodiment, the ratio of the weight % of the heat seal layer 118 and the tie layer 114 may be adjusted as needed to optimize the amount of each layer needed to achieve its respective purpose. Specifically, the ratio may be adjusted to ensure both that the heat seal layer 118 is applied at a sufficient weight to form the desired heat seal and that the tie layer 114 is applied at a sufficient weight to ensure that the bond to the substrate is sufficient. Thus, it will be appreciated that in this and other embodiments where a single extruder is used to form both the heat seal layer 118 and the tie layer 114, the minimum total weight may need to be increased to achieve both objectives.

The heat seal layer 118 and tie layer 114 may be present in any suitable relative amount. In one example, the ratio of the weight % of the heat seal layer 118 to the tie layer 114 may be about 4:1, about 3.5:1, about 3:1, about 2.5:1, about 2.57:1, about 2.0:1, about 1.5:1, about 1:1, or any other suitable ratio. The ratios may be adjusted as needed to provide the desired characteristics of the heat seal layer 118 and the tie layer 114 (and the resulting packaging material), as will be understood by those in the art.

Alternatively, each layer 114, 116, 118 of the material 100 may be formed using a separate extruder. In either scenario, one or more of the layers may be coextruded or may be formed and/or joined in a sequential manner. Numerous other processes are contemplated hereby.

It will be understood by those of skill in the art that one or more processing additives may be incorporated into any of the various layers as needed or desired. Thus, for example, some such layers or compositions may include surfactants, anti-foaming agents, plasticizers, and additives to modify abrasion resistance and slip. Other additives or components may be selected to improve adhesion to the substrate or to other layers or components within the packaging material, to increase resistance to oil permeation, or to provide other functions or attributes. Examples of such additives include, but are not limited to, organic or inorganic fillers, for example, talc, calcium carbonate, magnesium carbonate, silica, calcium oxide, alumina, titanium dioxide, any other filler, or any combination thereof. Numerous other possibilities are contemplated hereby.

The packaging material 100 may be formed into any suitable package, for example, a bag. The bag may have any shape and size as needed for a particular food item and application. For some applications, for example, for French fries, the bags may include slits or other features to permit the air to escape after filling the bag. This allows a plurality of bags to be packed more efficiently into boxes or other cartons for shipping.

Any suitable process may be used to form and fill the package. In many of such processes, heat is used to seal the open ends of the package together. However, any suitable adhesive, mechanical fastening, joining, or binding technique may be used.

Notably, as stated above, the addition of PP to the LDPE in the tie layer 114 raises the melting point of the blend to a temperature of above about 250° F., while the addition of LDPE to PP in the oil resistant layer lowers the melting point of the blend to a temperature of below 250° F. In this manner, when the packaging material 100 is heated to create a heat seal, the heat seal layer 118 softens without softening the tie layer 114.

Various aspects of the present invention are illustrated further by the following examples, which are not to be construed as limiting in any manner. All values are approximate, unless otherwise noted.

### Example 1

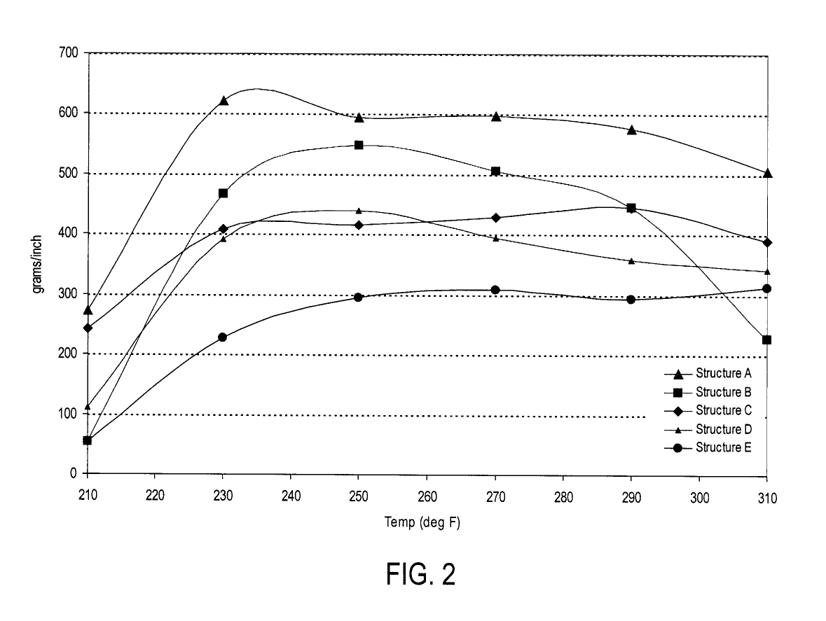

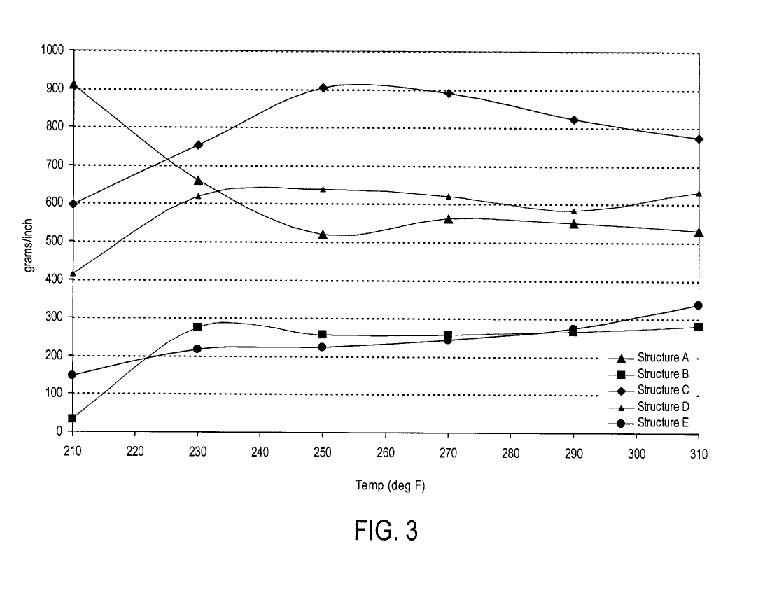

The hot tack strength and seal strength of various structures was evaluated using ASTM 1921-98 with a Lako Tools SL-10 Hot Tack and Seal Strength Tester over a temperature range of 210° F. to 310° F. at 20° F. intervals. The results are presented in Tables 1 and 2 and FIGS. 2 and 3. The structures evaluated were as follows:
Structure A: about 3.12 lb/ream blend A
   about 4.0 lb/ream PP
   about 0.88 lb/ream blend A
   about 38# natural Kraft paper
Structure B: about 3.12 lb/ream blend B
   about 4.0 lb/ream PP
   about 0.88 lb/ream blend B
   about 38# natural Kraft paper
Structure C: about 1.30 lb/ream blend A
   about 3.33 lb/ream LDPE
   0.37 lb/ream blend A
   38# natural Kraft paper
Structure D: about 1.30 lb/ream blend A
   about 3.33 lb/ream 80%/20% PP/LDPE
   about 0.37 lb/ream blend A
   about 38# natural Kraft paper
Structure E: about 1.30 lb/ream blend B
   about 3.33 lb/ream 80%/20% PP/LDPE
   about 0.37 lb/ream blend B
   about 38# natural Kraft paper

where:
Blend A: about 60% Dow Affinity PT 1450G1 LLPDE
   about 35% Chevron 1018 LDPE (8MI)
   about 5% DuPont Surlyn 1707 EMA
Blend B: about 95% Chevron 1018 LDPE (8MI)
   about 5% DuPont Surlyn 1707 EMA

TABLE 1
Hot tack strength (g/in)

| Jaw Temp | Structure | Structure | Structure | Structure | |
|---|---|---|---|---|---|
| (° F.) | A | B | C | D | Structure E |
| 210 | 272 | 54 | 242 | 112 | 54 |
| 230 | 621 | 466 | 408 | 391 | 228 |
| 250 | 594 | 548 | 415 | 439 | 295 |
| 270 | 598 | 506 | 429 | 395 | 309 |
| 290 | 576 | 445 | 446 | 359 | 294 |
| 310 | 506 | 227 | 390 | 342 | 313 |

As is evident from FIG. 2 and Table 1, the hot tack strength of Structures A and D, which include the LLDPE, was significantly higher (about 34% higher for Structure A; about 29% higher for Structure D) than the hot tack strength of Structures B and E, which are similar structures without the LLDPE.

TABLE 2
Seal strength (g/in)

| Jaw Temp | Structure | Structure | Structure | Structure | |
|---|---|---|---|---|---|
| (° F.) | A | B | C | D | Structure E |
| 210 | 910 | 32 | 596 | 414 | 147 |
| 230 | 659 | 275 | 753 | 619 | 217 |
| 250 | 519 | 256 | 903 | 639 | 223 |
| 270 | 562 | 256 | 891 | 620 | 243 |
| 290 | 551 | 266 | 822 | 584 | 275 |
| 310 | 530 | 280 | 775 | 632 | 338 |

As is evident from FIG. 3 and Table 2, the seal strength of Structures A and D, which include the LLDPE, was significantly higher (about 60% higher for Structure A; about 59% higher for Structure D) than the seal strength of Structures B and E, which are similar structures without the LLDPE.

### Example 2

The hot tack strength and seal strength of tightly bonded areas (bond pressure of about 400 psi) and loosely bonded areas (bond pressure of about 65 psi) of various structures was evaluated using ASTM 1921-98 with a Lako Tools SL-10 Hot Tack and Seal Strength Tester over a temperature range of 210° F. to 310° F. at 20° F. intervals. The results are presented in Table 3. The structures evaluated were as follows (with Structures A, C, and D being the same as Structures A, C, and D of Example 1)
Structure A: about 3.12 lb/ream blend A
   about 4.0 lb/ream PP
   about 0.88 lb/ream blend A
   about 38# natural Kraft paper
Structure C: about 1.30 lb/ream blend A
   about 3.33 lb/ream LDPE
   about 0.37 lb/ream blend A
   about 38# natural Kraft paper
Structure D: about 1.30 lb/ream blend A
   about 3.33 lb/ream 80%/20% PP/LDPE
   about 0.37 lb/ream blend A
   about 38# natural Kraft paper
Structure F: about 1.56 lb/ream blend A
   about 4.0 lb/ream 80%/20% PP/LDPE
   about 0.44 lb/ream blend A
   about 38# natural Kraft paper
Structure G: about 1.82 lb/ream blend A
   about 4.66 lb/ream 80%/20% PP/LDPE
   about 0.52 lb/ream blend A
   about 38# natural Kraft paper

where:
Blend A: about 60% Dow Affinity PT 1450G1 LLPDE
   about 35% Chevron 1018 LDPE (8MI)
   about 5% DuPont Surlyn 1707 EMA

TABLE 3

| | Structure A | Structure C | Structure G | Structure F | Structure D |
|---|---|---|---|---|---|
| Polymer system (lb/ream) | about 8 | about 5 | about 7 | about 6 | about 5 |
| Hot tack strength, loosely | — | 444 | 482 | 473 | 395 |
| bonded area (g/in) | | | | | |
| Hot tack strength, tightly | 598 | 471 | 574 | NT | NT |
| bonded area (g/in) | | | | | |
| Seal strength, | NA | 891 | 657 | 713 | 620 |
| loosely bonded area (g/in) | | | | | |
| Seal strength, | 562 | 835 | 873 | — | — |
| tightly bonded area (g/in) | | | | | |
| Oil resistance, loosely | — | — | excellent | excellent | good |
| bonded area | | | | | |
| Oil resistance, tightly | excellent | NT | NT | NT | fair |
| bonded area | | | | | |

Notably, the seal strength of Structure G exceeded that of Structure A in the tightly bonded areas, despite the fact that a lower weight polymer system was used. While not wishing to be bound by theory, it is presumed that the improved seal strength can be attributed to the presence of LDPE in the core layer.

Additionally, it is noted that the loosely bonded areas of Structures F and G provided about the same level of oil resistance as the tightly bonded areas of Structure A, despite the fact that a lower weight polymer system was used in Structures F and G.

Further, it is noted that in Structure D, the loosely bonded areas provided greater oil resistance than the tightly bonded areas.

### Example 3

Packaging material having the following structures were made:

Structure H: about 1.2 mil BOPP film (heat sealable)
about 8 lb/ream 85% LDPE/15% PP
about 60 lb/ream Kraft paper
about 1.19 lb/ream 60% m-LLDPE/35% LDPE/5% EMA
about 3.75 lb/ream 85% PP/15% LDPE
about 3.06 lb/ream 60% m-LLDPE/35% LDPE/5% EMA

Structure J: about 1.2 mil BOPP film (heat sealable)
about 8 lb/ream 85% LDPE/15% PP
about 4 lb/ream carbon black/aluminum flake (about 2.15:1)
about 60 lb/ream Kraft paper
about 1.19 lb/ream 60% m-LLDPE/35% LDPE/5% EMA
about 3.75 lb/ream 85% PP/15% LDPE
about 3.06 lb/ream 60% m-LLDPE/35% LDPE/5% EMA

Various properties of the packaging materials were measured. The results are set forth in Table 4.

TABLE 4

| | Structure H | Structure J |
|---|---|---|
| Total Weight (lbs/ream) | 97.6 | 99.2 |
| MD Tensile (lb/in) | 62.5 | 56.6 |
| CD Tensile (lb/in) | 52.59 | 55.68 |
| MD Tear (g) | 184 | 195 |
| CD Tear (g) | 239 | 255 |
| Caliper (mil) | 8.10 | 7.83 |
| MD Gurley stiffness, MD | 497 | 455 |
| Gurley stiffness, CD | 513 | 444 |

Although certain embodiments of this invention have been described with a certain degree of particularity, those skilled in the art could make numerous alterations to the disclosed embodiments without departing from the spirit or scope of this invention. All directional references (e.g., over, under, inner, outer, upper, lower, upward, downward, left, right, leftward, rightward, top, bottom, above, below, vertical, horizontal, clockwise, and counterclockwise) are used only for identification purposes to aid the reader's understanding of the various embodiments of the present invention, and do not create limitations, particularly as to the position, orientation, or use of the invention unless specifically set forth in the claims. Joinder references (e.g., joined, attached, coupled, connected, and the like) are to be construed broadly and may include intermediate members between a connection of elements and relative movement between elements. As such, joinder references do not necessarily imply that two elements are connected directly and in fixed relation to each other. Further, all percentages herein are weight percentages, unless specified otherwise.

It will be recognized by those skilled in the art, that various elements discussed with reference to the various embodiments may be interchanged to create entirely new embodiments coming within the scope of the present invention. It is intended that all matter contained in the above description or shown in the accompanying drawings shall be interpreted as illustrative only and not limiting. Changes in detail or structure may be made without departing from the spirit of the invention. The detailed description set forth herein is not intended nor is to be construed to limit the present invention or otherwise to exclude any such other embodiments, adaptations, variations, modifications, and equivalent arrangements of the present invention.

Accordingly, it will be readily understood by those persons skilled in the art that, in view of the above detailed description of the invention, the present invention is susceptible of broad utility and application. Many adaptations of the present invention other than those herein described, as well as many variations, modifications, and equivalent arrangements will be apparent from or reasonably suggested by the present invention and the above detailed description thereof, without departing from the substance or scope of the present invention.

While the present invention is described herein in detail in relation to specific aspects, it is to be understood that this detailed description is only illustrative and exemplary of the present invention and is made merely for purposes of providing a full and enabling disclosure of the present invention and to provide the best mode contemplated by the inventor or inventors of carrying out the invention. The detailed description set forth herein is not intended nor is to be construed to limit the present invention or otherwise to exclude any such other embodiments, adaptations, variations, modifications, and equivalent arrangements of the present invention.

What is claimed is:

1. A packaging material having first and second sides opposite one another, the packaging material comprising:
a polymer film layer;
a paper layer; and
a tie layer joining the paper layer and the polymer film layer,
wherein the first and second sides each comprise a heat sealable material, the heat sealable material of the second side comprising a blend of linear low density polyethylene, low density polyethylene, and ethylene/methacrylic acid copolymer.

2. The packaging material of claim 1, wherein the heat sealable material of the second side of the packaging material comprises about 60% linear low density polyethylene, about 35% low density polyethylene, and about 5% ethylene/methacrylic acid copolymer.

3. The packaging material of claim 2, wherein the tie layer comprises a blend of low density polyethylene and polypropylene.

4. The packaging material of claim 3, wherein the tie layer comprises about 85% low density polyethylene and about 15% polypropylene by weight.

5. The packaging material of claim 3, wherein the first side of the packaging material comprises the polymer film layer.

6. The packaging material of claim 5, wherein the polymer film layer comprises biaxially oriented polypropylene.

7. The packaging material of claim 1, further comprising a stain masking layer overlying the paper layer, such that the stain masking layer is disposed between the paper layer and the heat sealable polymer film.

8. The packaging material of claim 7, wherein the stain masking layer comprises carbon black and aluminum flake in a ratio of about 2.25 to 1.

9. The packaging material of claim 1, further comprising an oil resistant layer disposed between the paper layer and the second side of the packaging material.

10. The packaging material of claim 9, wherein the oil resistant layer comprises a blend of density polyethylene and polypropylene.

11. The packaging material of claim 9, wherein the oil resistant layer comprises about 15% low density polyethylene and about 85% polypropylene by weight.

12. The packaging material of claim 9, wherein
the tie layer is a first tie layer, and
the packaging material further comprises a second tie layer joining the oil resistant layer to the substrate.

13. The packaging material of claim 12, wherein the second tie layer comprises a blend of linear low density polyethylene, low density polyethylene, and ethylene/methacrylic acid copolymer.

14. The packaging material of claim 13, wherein the second tie layer comprises about 60% linear low density polyethylene, about 35% low density polyethylene, and about 5% ethylene/methacrylic acid copolymer by weight.

15. A packaging material comprising:
a paper layer having a first side and a second side opposite one another;
a heat sealable polymer film joined to the first side of the paper layer, the heat sealable film defining a first side of the packaging material;
a heat seal layer on the second side of the paper layer, the heat seal layer defining a second side of the packaging material, the heat seal layer comprising a blend of linear low density polyethylene, low density polyethylene, and ethylene/methacrylic acid copolymer; and
an oil resistant layer disposed between the heat seal layer and the second side of the paper layer.

16. The packaging material of claim 15, wherein the heat seal layer comprises about 60% linear low density polyethylene, about 35% low density polyethylene, and about 5% ethylene/methacrylic acid copolymer.

17. The packaging material of claim 15, wherein the heat sealable polymer film layer comprises polypropylene.

18. The packaging material of claim 15, wherein the heat sealable polymer film layer comprises biaxially oriented polypropylene.

19. The packaging material of claim 18, wherein the oil resistant layer comprises at least one of polypropylene and low density polyethylene.

20. The packaging material of claim 19, wherein the oil resistant layer comprises about 85% polypropylene and about 15% low density polyethylene by weight.

21. The packaging material of claim 15, further comprising a tie layer joining the oil resistant layer to the second side of the paper layer.

22. The packaging material of claim 21, wherein the weight percent ratio of the heat seal layer, core layer, and tie layer is about 3.06:3.15:1.

23. The packaging material of claim 21, wherein the tie layer comprises a blend of linear low density polyethylene, low density polyethylene, and ethylene/methacrylic acid copolymer.

24. The packaging material of claim 23, wherein the tie layer comprises about 60% linear low density polyethylene, about 35% low density polyethylene, and about 5% ethylene/methacrylic acid copolymer by weight.

25. The packaging material of claim 21, wherein
the heat seal layer has a basis weight of from about 2 to about 4 lb/ream,
the core layer has a basis weight of from about 2 to about 6 lb/ream, the core layer comprising a blend of polypropylene and low density polyethylene, and
the tie layer has a basis weight of from about 0.75 to about 2 lb/ream, the tie layer comprising a blend of linear low density polyethylene, low density polyethylene, and ethylene/methacrylic acid copolymer.

26. The packaging material of claim 25, further comprising a stain masking layer overlying the first side of the substrate, such that the stain masking layer is disposed between the substrate and the heat sealable polymer film.

27. The packaging material of claim 26, wherein the stain masking layer comprises carbon black and aluminum flake in a ratio of about 2.25 to 1.

28. The packaging material of claim 25, wherein
the tie layer is a first tie layer, and
the packaging material further comprises a second tie layer joining the substrate to the heat sealable polymer film layer.

29. The packaging material of claim 28, wherein the second tie layer comprises a blend of low density polyethylene and polypropylene.

30. The packaging material of claim 29, wherein the second tie layer comprises about 85% low density polyethylene and about 15% polypropylene by weight.

31. A packaging material comprising, in a layered configuration:
a heat sealable polymer film, the heat sealable polymer film defining a first side of the packaging material;
a first tie layer;
a paper layer;
a second tie layer;
an oil resistant layer; and
a heat seal layer comprising a blend of linear low density polyethylene, low density polyethylene, and ethylene/methacrylic acid copolymer, the heat seal layer defining a second side of the packaging material.

32. The packaging material of claim 31, wherein
the heat sealable polymer film comprises biaxially oriented polypropylene;
the first tie layer comprises a blend of low density polyethylene and polypropylene;
the second tie layer comprises a blend of linear low density polyethylene, low density polyethylene, and ethylene/methacrylic acid copolymer; and
the oil resistant layer comprises a blend of low density polyethylene and polypropylene.

33. The packaging material of claim 31, wherein
the heat sealable polymer film comprises biaxially oriented polypropylene;
the first tie layer comprises about 85% low density polyethylene and about 15% polypropylene;
the second tie layer comprises about 60% linear low density polyethylene, about 35% low density polyethylene, and about 5% ethylene/methacrylic acid copolymer;
the oil resistant layer comprises about 15% low density polyethylene and about 85% polypropylene; and
the heat seal layer comprises about 60% linear low density polyethylene, about 35% low density polyethylene, and about 5% ethylene/methacrylic acid copolymer.

34. The packaging material of claim 31, further comprising a stain masking layer disposed between the paper layer and the heat sealable polymer film.

35. The packaging material of claim 34, wherein the stain masking layer comprises carbon black and aluminum flake in a ratio of about 2.25 to 1.
